(19) United States
(12) Patent Application Publication
(10) Pub. No.: US 2007/0078979 A1
(43) Pub. Date: Apr. 5, 2007

(54) Reducing load at a mail server

(75) Inventors: Rajendra Singh Sisodia, Bhopal (IN); Vemula Srinivasarao, Banglore (IN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/572,467

(22) PCT Filed: Sep. 2, 2004
(86) PCT No.: PCT/IB04/51671

§ 371 Date: Mar. 20, 2006

(30) Foreign Application Priority Data
Sep. 23, 2003 (EP) 03103513.2

(51) Int. Cl. G06F 15/173

(52) U.S. Cl. 709/225

(57) ABSTRACT

A method for reducing the load on a mail server (202) of a mail system. Uses information about users' schedule and/or habits in order to evaluate whether or not a user is likely to be at his/her desk at a specific time. E-mail is only retrieved from server if it is likely that the user is at his/her desk and thereby likely to read the e-mail. May use information from calendar entries in electronic calendars. Reduces the load on the server without reducing the service provided to the users. May further be used to prune e-mail so that some e-mails may be deleted or deferred.

### FIELD OF THE INVENTION

The present invention relates to a method for reducing the load at a mail sever by using already available information about the users of the mail system. More particularly, the present invention relates to a method for reducing the load at a mail server by using information about the schedules and regular habits of the users.

### BACKGROUND OF THE INVENTION

WO 96/35994 discloses a system for managing electronic messages. Recipients of electronic messages may define a set of rules for accepting incoming messages. The rules are applied by a message distributor at substantially the initial point of distribution so that delays in routing messages are reduced. The distributor makes sure that the rules are applied (e.g. automatically forwarding certain messages to certain other recipients), even if the recipient is not present. Furthermore, since the rules are applied at an initial point, the network traffic is reduced because the forwarded messages do not need to go from the recipient and back to the distributor before being redistributed to the other recipients.

It is an object of the present invention to provide a method for reducing the load at a mail server without reducing the service level for mail services to users who are working at their client device.

It is a further object of the present invention to provide a method which optimizes the use of a mail server so that messages which are unlikely to be read immediately may be delayed.

### SUMMARY OF THE INVENTION

According to a first aspect of the present invention the above and other objects are fulfilled by providing a method for reducing the load at a mail server in a mail system comprising a mail server, at least one mail client, each mail client being adapted to establish a connection to the mail server and to interrupt such a connection, the mail system further comprising a schedule frame set comprising, for each mail client, information about the schedule of a user being associated with said mail client,

method comprising the steps of:
a mail client consulting the schedule frame set in order to obtain information about
the current schedule of the user being associated with said mail client,
the mail client evaluating the obtained information,
the mail client deciding whether or not to establish a connection to tile mail server, based on the result of the evaluating step,
in case the mail client decides that a connection should be established:
   establishing a connection to the mail server,
   requesting new mail pieces from the mail server,
   retrieving new mail pieces, if any, from the mail server,
   interrupting the connection,
in case the mail client decides that a connection should not be established:
   abstaining from establishing a connection to the mail server.

According to a second aspect of the present invention the above and other objects are fulfilled by providing a mail system comprising:
a mail server,
at least one mail client, each mail client being adapted to establish a connection to the mail server and to interrupt such a connection,
a schedule frame set comprising, for each mail client, information about the schedule of a user being associated with said mail client,

each mail client comprising:
means for consulting the schedule frame set in order to obtain information about the current schedule of the user being associated with said mail client,
means for evaluating the obtained information,
means for deciding whether or not to establish a connection to the mail server, based on the evaluated information,
means for requesting new mail pieces from the mail server, and
means for retrieving new mail pieces from the mail server.

The mail server may be any suitable kind of server device which has one or more processing devices (processors) and attached storage means. This storage means is either directly connected to the mail server or connected via a network (e.g. LANs or WANs) via wired or wireless link medium. The mail server is responsible for storing e-mails on/from the attached storage means for all users connected to it via mail clients. The mail server is also responsible for relaying the e-mails it receives from the mail clients. The mail server may even be a number of devices which are interconnected so as to form a ‘common’ server device, in the sense that a user will not feel the difference between contacting one server device and the number of server devices.

Similarly, the mail client may be any suitable kind of computer device, such as a personal computer (PC), a computer terminal, a portable device having build-in mail client capability, or a portable device which provides the mail client capability via an external means, etc.

The connection between the mail server and the mail client may be a wired connection, or it may be wireless connection, such as a radio frequency (RF) connection, an infrared (IR) connection, etc. Preferably, the connection is established via a computer network comprising at least the mail server and the mail clients. The network may be a Local Area Network (LAN) or it may be a Wide Area Network (WAN), or it may be any other suitable kind of network.

Thus, according to the present invention, the mail client evaluates whether or not the user being associated with the mail client is currently likely to be wanting to read his or her e-mails. If the user is likely to be wanting to read the e-mails, the mail server will be contacted and the e-mails retrieved in a normal manner. If the user is unlikely to wanting to read the e-mails, the mail client will not establish a connection to the mail server. Therefore, e-mails are only retrieved if and when they are likely to be read. Thereby the load on the mail server is reduced because only some of the mail clients of the mail system will be contacting the mail server at a given time. This is very advantageous because the loads on a mail server under normal circumstances may be very large, thereby possibly requiring a large server device. By applying the present invention, the load may be reduced as described above, and consequently a smaller server device may be chosen (as compared to what would normally be needed in order to ensure a sufficiently efficient mail distribution). The invention is also very advantageous because it reduces the load on the mail server without reducing the service provided to the users, i.e. the users will not feel the difference. Thus, the method according to the present invention does not alter the user preferences but merely exploits the periods in which the users do not need to check e-mails.

Furthermore, the evaluation is performed on the basis of information which is already available in usual mail systems, e.g. information contained in the electronic calendars of the users of the system.

The evaluating step may comprise evaluating if the user is currently likely to be present at the mail client, in which case the mail client may decide that a connection should be established if the user is likely to be present at the mail client, and that a connection should not be established if the user is not likely to be present at the mail client.

The evaluating step may, thus, comprise evaluating whether or not there is an entry in the user's schedule at the present time. The user's schedule preferably comprises an electronic calendar showing the appointments that the user has arranged or accepted. Such an electronic calendar may preferably be an integrated part of the e-mail software used by the e-mail system. Thus, if there is an entry in the user's schedule, the user is likely to be away from his or her desk, e.g. because he or she is in a meeting or away on vacation or a conference. Alternatively, he or she may be busy, even if he or she is at or near his or her desk.

The evaluating step may also comprise, in case there is an entry in the user's schedule, evaluating whether or not the entry is of an ‘out of office’ type, such as ‘meeting’, ‘vacation’, ‘conference’, etc. An entry may also be of a kind which does not imply that the user will be away from his or her desk, such as ‘working on a specific project’, ‘telephone conference’, ‘internal meeting in my office’, etc. When such entries are in the schedule, the user may want to receive e-mails during the time during which the entry extends, and the mail client should therefore establish connections to the mail server as usual.

The method may further comprise the step of repeating the steps of the method at certain time intervals. In this case the mail client checks whether or not a connection should be established at certain time intervals, such as every 30 seconds, every 2 minutes, every 10 minutes, etc., according to the preferences of the user or the settings decided by the corporation.

Alternatively or additionally, the steps may be performed in response to an action performed by a user. In this case the user may choose to initiate the procedure at a certain time, e.g. because he or she just received a telephone call from somebody informing him or her that an e-mail has just been sent, or because he or she has returned from a meeting earlier than expected. The user may then perform one or more specific key strokes or use the computer mouse to click an icon on the screen, thereby initiating the procedure.

Alternatively or additionally, each mail client may comprise data storage means, in which case the steps may be initiated by a computer program stored in the data storage means of the mail client. In this case the computer program ‘decides’ when the procedure shall be initiated. This will typically be at certain time intervals. However, the computer program may alternatively be adapted to initiate the procedure at various time intervals, e.g. depending on the time of the day. Thus, during normal office hours the procedure may be initiated more often than in the middle of the night when it is not as likely that the user will be present

The schedule frame set may further comprise information relating to corporate habits and individual habits of the user associated with the mail client, in which case the evaluation step may further comprise evaluating said information.

Corporate habits may comprise office hours, normal lunch break time, meetings which all employees have to participate in, etc. Individual habits may comprise preferred working time or lunch break for that particular individual. The system may further be adapted to ‘learn’ about corporate or individual habits, e.g. by means of a neural network.

The method may further comprise the step of, in case the mail client decides that a connection should be established:
deciding which new mail pieces should be presently retrieved, which new sail pieces should be deferred, and which new mail pieces should be deleted from the mail server, based on certain criteria,
and wherein the step of retrieving new mail pieces comprises retrieving only the new mail pieces which are deemed to be presently retrieved.

The certain criteria may e.g. be set by the user and/or by the corporation. Thus, the user and/or the corporation may, e.g., decide that e-mails originating from one or more specific senders or including specific words in the text or the subject should be deleted immediately. This may be desirable in order to avoid spam mail or the like.

The criteria are preferably dynamical in the sense that they may be changed over time and according to various needs and desires which may occur.

In case the user is out of office for a longer period of time (e.g. on vacation, ill or attending a conference), the mail client may decide to establish connections to the mail server every now and then, e.g. once or twice every day or once or twice every week. Such connections may advantageously be established during normal closing hours, such as in the middle of the night when other users are not putting a load on the mail server. When the user knows that he or she will be away for a longer period of time, he or she may, thus, set up a criterion that e-mails which will be outdated when the user returns are deleted. Such e-mails may be e-mails from news groups, specific mailing lists, magazines, etc. Thus, these e-mail will be deleted while the user is absent, thereby reducing the load on the server memory as well as the traffic load on the connection between the mail server and the mail client.

Furthermore, the user may want to defer personal e-mails until after office hours. Thus, the user may set up a criterion that e-mails from specific senders are to be deferred until after closing time.

Thus, the individual user as well the corporation may control which e-mails should be delivered at which time, and which e-mails should not be delivered at all. Thereby, the users will not be disturbed by e-mails which are not desired or not desired at specific times.

Alternatively or additionally, the method may further comprise the step of updating the mail server with information relating to types of mail pieces which should be deleted from the mail server for a certain period of time, and with information relating to said period of time.

In this embodiment the user may set up criteria as described above before he or she starts a vacation or goes to a conference. The criteria are preferably set up to be valid only during the period of time in which the user will be absent.

### BRIEF DESCRIPTION OF THE DRAWINGS

FIG. 1 shows a flow chart describing the method according to the present invention,

FIG. 2a shows calendar entries for a user associated with a mail client, and

FIG. 2b shows the connection mechanism between a mail server and the mail client of FIG. 2a.

### DESCRIPTION OF PREFERRED EMBODIMENTS

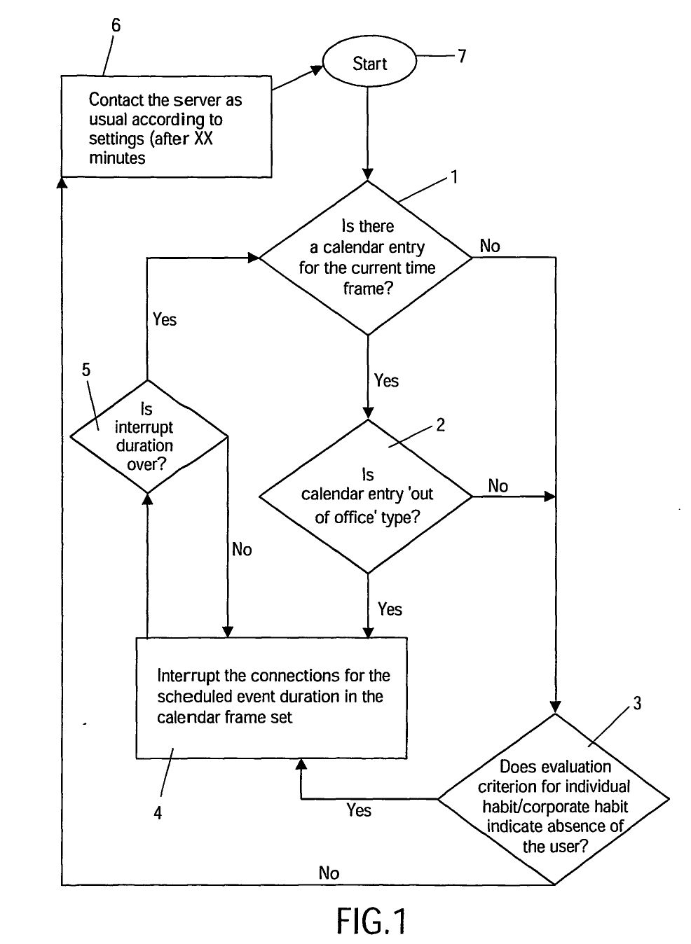

FIG. 1 is a flow chart describing the method according to the present invention. Normally, a mail client will contact the mail server at regular time intervals, such as every minute or once every 30 seconds, etc. Instead of merely contacting the mail server when the normal time since the last contact has elapsed, the system according to the present invention will consult the calendar of the user associated with the mail client at step 1 in order to establish whether or not there is a calendar entry for this specific user for the current time frame.

In case there is a calendar entry for the current time frame, the system will establish, at step 2, whether or not the entry is of an ‘out of office’ type. An ‘out of office’ type of entry is an entry indicating that the user is not likely to be at his or her desk, such as a ‘meeting’ entry, a ‘vacation’ entry, a ‘conference’ entry etc.

In case there is no calendar entry for the current time frame, or in case the calendar entry is not of an ‘out of office’ type, the system goes on to establish whether or not there are other indications that the user is not at his or her desk. Thus, at step 3, the system investigates whether or not individual habits and/or corporate habits indicate that the user is not at his/her desk. Such habits may, e.g., be normal time for lunch break, normal working hours (individual or corporate), etc.

If it is established that there is an ‘out of office’ type calendar entry, or that there are individual or corporate habits which indicate that the user is not at his/her desk, it is determined at step 4 that no connections shall be established to the mail server for the duration of the calendar entry or the habit(s). At certain time intervals the system interrogates, at step 5, if the interrupt duration is over. If it is not over, one is returned to step 4 in order to continue the interruption.

When the interrupt duration is over, one is returned to step 1 in order to determine whether or not a new calendar entry and/or a new individual or corporate habit indicates that the user is still not at his/her desk.

When it is established that neither a calendar entry nor an individual or corporate habit indicates that the user is not at his/her desk, the server is contacted 6 as usual according to the normal settings.

After the server has been contacted as usual according to the settings 6, one is returned to start 7 in order to restart the procedure.

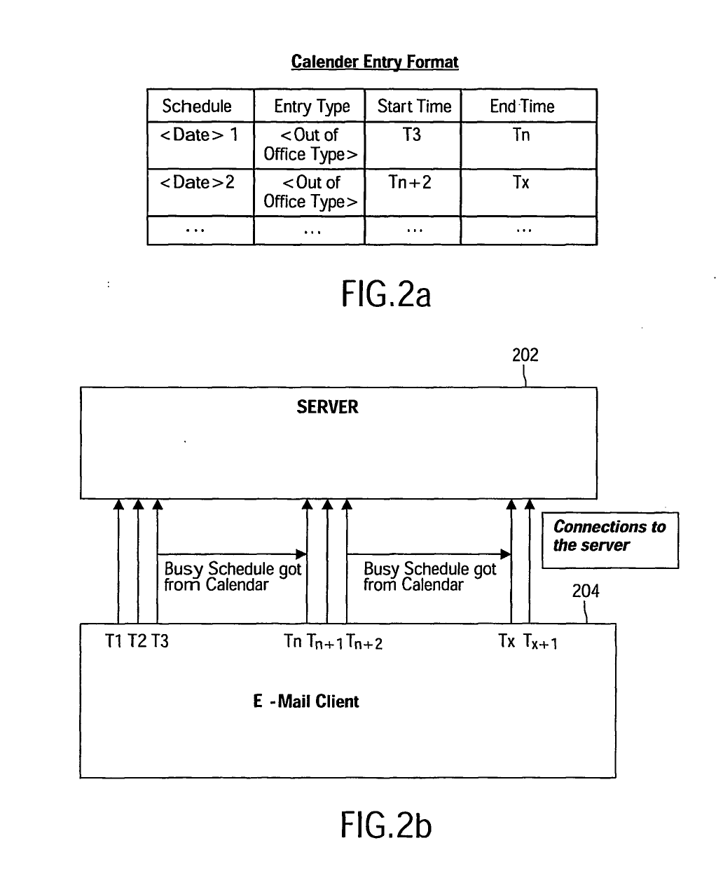

FIG. 2a shows calendar entries for a user associated with a mail client. Two entries are shown, one starting at time T3 and ending at time Tn, and one starting at time Tn+2 and ending at time Tx.

FIG. 2b shows the connection mechanism between the mail server 202 and the mail client 204 associated with the user whose calendar entries are shown in FIG. 2a. Normally the mail client contacts the mail server at regular time intervals, T1, T2, T3, etc. Since the calendar entries indicate that the user is busy from time T3 until time Tn, the connections are interrupted during this period of time. The connections are then resumed at times Tn, Tn+1 and Tn+2. Then the second entry shown in FIG. 2a begins, and the connections are accordingly interrupted until time Tx where they are resumed once again. Thus, the load on the mail server is considerably reduced since the mail client shown in FIG. 2 will not contact the mail server during the shown time intervals (T3 to Tn and Tn+2 to Tx).

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second ” etc. do not preclude a plurality.

1. A method for reducing the load at a mail server in a mail system comprising a mail server, at least one mail client, each mail client being adapted to establish a connection to the mail server and to interrupt such a connection, the mail system further comprising a schedule frame set comprising, for each mail client, information about the schedule of a user being associated with said mail client,
the method comprising the steps of:
a mail client consulting the schedule frame set in order to obtain information about the current schedule of the user being associated with said mail client,
the mail client evaluating the obtained information,
the mail client deciding whether or not to establish a connection to the mail server, based on the result of the evaluating step,
in case the mail client decides that a connection should be established:
establishing a connection to the mail server,
requesting new mail pieces from the mail server,
retrieving new mail pieces, if any, from the mail server,
interrupting the connection,
in case the mail client decides that a connection should not be established:
abstaining from establishing a connection to the mail server.

2. A method according to claim 1, wherein the evaluating step comprises evaluating if the user is currently likely to be present at the mail client, and wherein the mail client decides that a connection should be established if the user is likely to be present at the mail client, and that a connection should not be established if the user is not likely to be present at the mail client.

3. A method according to claim 2, wherein the evaluating step comprises evaluating whether or not there is an entry in the user's schedule at the present time.

4. A method according to claim 1, further comprising the step of repeating the steps of the method at certain time intervals.

5. A method according to claim 1, wherein the steps are performed in response to an action performed by a user.

6. A method according to claim 1, wherein each mail client comprises data storage means, and wherein the steps are initiated by a computer program stored in the data storage means of the mail client.

7. A method according to claim 1, wherein the schedule frame set further comprises information relating to corporate habits and individual habits of the user associated with the mail client, and wherein the evaluation step further comprises evaluating said information.

8. A method according to claim 1, further comprising the step of, in case the mail client decides that a connection should be established:
deciding which new mail pieces should be presently retrieved, which new mail pieces should be deferred, and which new mail pieces should be deleted from the mail server, based on certain criteria,
and wherein the step of retrieving new mail pieces comprises retrieving only the new mail pieces which are deemed to be presently retrieved.

9. A method according to claim 1, further comprising the step of updating the mail server with information relating to types of mail pieces which should be deleted from the mail server for a certain period of time, and with information relating to said period of time.

10. A mail system comprising:
a mail server (202),
at least one mail client (204), each mail client being adapted to establish a connection to the mail server (202) and to interrupt such a connection,
a schedule frame set comprising, for each mail client (204), information about the schedule of a user being associated with said mail client (204),
each mail client comprising:
means for consulting the schedule frame set in order to obtain information about the current schedule of the user being associated with said mail client (204),
means for evaluating the obtained information,
means for deciding whether or not to establish a connection to the mail server (202), based on the evaluated information,
means for requesting new mail pieces from the mail server (202), and
means for retrieving new mail pieces from the mail server (202).
